(19) United States
(12) Patent Application Publication
(10) Pub. No.: US 2024/0367141 A1
(43) Pub. Date: Nov. 7, 2024

(54) PARTICULATE HYDROXYAPATITE (HA) SUBSTRATES AND USES THEREOF

(71) Applicant: BIO-RAD LABORATORIES, INC., HERCULES, CA (US)

(72) Inventors: BRIAN PANGANIBAN, HERCULES, CA (US); SHAWN DARNALL, HERCULES, CA (US); DANNI WANG, HERCULES, CA (US); CHRISTOPHER BELISLE, WALNUT CREEK, CA (US)

(21) Appl. No.: 18/652,860

(22) Filed: May 2, 2024

Related U.S. Application Data
(60) Provisional application No. 63/463,318, filed on May 2, 2023.

(51) Int. Cl. B01J 20/04; B01D 15/20; B01D 15/42; B01J 20/282; B01J 20/30; B01J 20/32

(52) U.S. Cl. CPC B01J 20/048; B01D 15/20; B01D 15/424; B01J 20/282; B01J 20/3071; B01J 20/3204; B01J 20/3234; B01J 2220/52

(57) ABSTRACT

This disclosure relates to particulate hydroxyapatite (HA)-coated substrates, methods of making particulate HA-coated substrates, and methods of using particulate HA-coated substrates. Thus, the disclosure provides chromatography media composed of a particulate substrate (such as polymer beads or other particulate substrates) that is coated with HA. Also provided is a chromatography media (optionally contained within a column) comprising a HA-coated substrate (e.g., a plurality of beads or another particulate substrate that is coated with HA). The beads or particulate substrate can be a porous or non-porous substrate.

### CROSS-REFERENCE TO RELATED APPLICATION

This application claims the benefit of U.S. Provisional Application Ser. No. 63/463,318, filed May 2, 2023, the disclosure of which is hereby incorporated by reference in its entirety, including all figures, tables and amino acid or nucleic acid sequences.

Hydroxyapatite (HA) purification media has several drawbacks. Ceramic hydroxyapatite (CHT), for example, is complicated and expensive to produce and is difficult to pack into columns. CHT and other HA-media are also mechanically unstable and can fragment into pieces, resulting in column pressure increases. CHT or HA-media, therefore, cannot be compressed during column preparation, making packing difficult. Lastly, CHT and other HA-media can dissolve at low pH, disturbing the bed during operation. This disclosure provides a new hydroxyapatite chromatography media that solves several of these drawbacks. The disclosed HA media is compressible, resistant to bed collapse at low pH, and easy to pack into columns. Its production is also less complicated as compared to CHT and it can be produced at a fraction of the cost.

### BRIEF SUMMARY OF THE INVENTION

Provided herein is a chromatography media composed of a particulate substrate (such as polymer beads or other particulate substrates) that is coated with HA. Also provided is a chromatography media (optionally contained within a column) comprising a HA-coated substrate (e.g., a plurality of beads or another particulate substrate that is coated with HA). The beads or particulate substrate can be a porous or non-porous substrate.

Also provided is a method of preparing the HA-coated particulate substrate. In some embodiments, the method comprises incubating a particulate substrate comprising epoxide groups, with phosphoric acid to form a substrate bearing phosphate groups. The phosphoric acid-derivatized substrate can then be mineralized with calcium phosphate to form a substrate coated with calcium phosphate (e.g., a brushite form of calcium phosphate). The calcium phosphate can then be treated with a base (such as sodium hydroxide) to form the HA-coated substrate. FIG. 2 illustrates one embodiment of this process.

Also provided are methods of performing chromatography. In some embodiments, the method comprises contacting a sample comprising a target molecule with a HA-coated particulate substrate as disclosed herein under conditions such that the target is not captured by the particulate HA-coated substrate; and collecting the target molecule in flow-through from the particulate HA-coated substrate.

In other embodiments, the method comprises contacting a sample comprising a target molecule with a particulate HA-coated substrate as disclosed herein under conditions such that the target is captured by the particulate HA-coated substrate; and collecting the target molecule in an eluate from the particulate HA-coated substrate.

In some embodiments, the sample comprises a contaminant that is captured by the particulate HA-coated substrate. In some embodiments, the collecting step comprises collecting one or more fractions enriched for the target molecule from the particulate HA-coated substrate. In other embodiments, the collecting step comprises applying centrifugal force or a vacuum to the particulate HA-coated substrate and collecting one or more fractions enriched for the target molecule from the particulate HA-coated substrate. In some embodiments, the protein is an antibody or another therapeutic protein. In some embodiments, the protein is an IgG antibody.

### BRIEF DESCRIPTION OF THE DRAWINGS

FIG. 1 is an schematic of an substrate (R) comprising a functional group (X) selected from a sulfate group, a carboxylate group and/or a phosphate group. The substrate is illustrated as a bead which can comprise methacrylate, polystyrene, agarose, cellulose, dextran, or polyacrylamide.

FIG. 2 illustrates an exemplary method by which HA can be formed on particles.

FIG. 3. Resin imaged by scanning electron microscopy, showing a resin well-covered in calcium phosphate needle-like structures.

FIG. 4 and FIG. 5. Resin imaged by scanning electron microscopy, showing resins well-covered in calcium phosphate needle-like structures. Some beads were purposefully broken to show that a solid base polymer core covered in the CaP shell (FIG. 5).

FIG. 6. Resin imaged by scanning electron microscopy, showing resins well-covered in calcium phosphate needle-like structures.

FIG. 7. Resin imaged by scanning electron microscopy, showing resins well-covered in calcium phosphate needle-like structures.

FIG. 8, FIG. 9 and FIG. 10. Resin imaged by scanning electron microscopy, and 10,000× images show the resin is covered in rough surface of calcium phosphate (FIG. 8). Distinct needles were not observed, and 50,000× magnification shows a smoother surface speckled with holes. Depending on the quality of washing, some batches had larger plate-like CaP structures embedded in the surface or formed separately from the resin surface (FIG. 9). Resin was analyzed by FT-IR (Fourier transform infrared spectroscopy) showing a hydroxyapatite like signature with broad peaks (FIG. 10).

FIG. 11. Resin imaged by scanning electron microscopy, showing a resin well-covered in hydroxyapatite needle-like structures.

FIG. 12. Resin imaged by scanning electron microscopy, and 10,000× images show the resin is covered in rough surface of calcium phosphate.

FIGS. 13A-13D. Chromatographic performance of Macro-Prep HA (material from example 5). 1.2 mL of Macro-Prep HA is packed in a 1 mL chromatography column compared to commercial resins (CHT Type II, FIG. 13A, Macro-Prep HA, FIG. 13B, Tosoh Ca Pure-HA, FIG. 13C, and Sartorius HA Ultrogel, FIG. 13D).

FIG. 14. Chromatographic performance of Macro-Prep HA.

### DETAILED DESCRIPTION OF THE INVENTION

This disclosure relates to particulate HA-coated substrates, methods of making particulate HA-coated substrates, and methods of using particulate HA-coated substrates.

### Definitions

The term “hydroxyapatite” refers to an insoluble hydroxylated mineral of calcium phosphate with the structural formula Ca₁₀(PO₄)₆(OH)₂. Hydroxyapatite chromatography is considered a multimodal process in that it has multiple modes of interaction with biomolecules. Its dominant modes of interaction are phosphoryl cation exchange and calcium metal affinity. Hydroxyapatite is commercially available in a variety of forms including, but not limited to, ceramic hydroxyapatite which is a chemically pure form of hydroxyapatite that has been sintered at high temperature to modify it from a crystalline to a ceramic form. Ceramic hydroxyapatite is spherical in shape, with particle diameters ranging from about 10 microns to about 100 microns, and is typically available at nominal diameters of 20 microns, 40 microns, and 80 microns. Ceramic hydroxyapatite (or CHT) is macroporous, and is available in three types: Type I, with a medium porosity and a relatively high binding capacity: Type II, with a larger porosity and a lower binding capacity; and XT, which has properties between Type I and Type II. All of the apatite-based HA-coated substrates in this paragraph are available from Bio-Rad Laboratories. Inc. (Hercules. Calif., USA).

The term “antibody” refers to an immunoglobulin or fragmentary form thereof. The term includes, but is not limited to, polyclonal or monoclonal antibodies of the classes IgA, IgD, IgE, IgG, and IgM, derived from human or other mammalian cell lines, including natural or genetically modified forms such as humanized, human, single-chain, chimeric, synthetic, recombinant, hybrid, mutated, grafted, and in vitro generated antibodies. “Antibody” encompasses composite forms including, but not limited to, fusion proteins containing an immunoglobulin moiety “Antibody” also includes antibody fragments such as Fab, F(ab′)₂, Fv, scFv, Fd, dAb, Fe and other compositions, whether or not they retain antigen-binding function.

The term “protein” is used to denote an amino acid polymer or a set of two or more interacting or bound amino acid polymers. The term applies to amino acid polymers in which one or more amino acid residue is an artificial chemical mimetic of a corresponding naturally occurring amino acid, as well as to naturally occurring amino acid polymers, those containing modified residues, and non-naturally occurring amino acid polymers. The term “protein” includes therapeutic proteins, including, but are not limited to, Factor VIII von Willebrand Factor enzymes, growth regulators, clotting factors, cytokines, hormones, transcription factors and phosphoproteins.

The term “HA-coated substrate” as referred to within this disclosure is meant to denote a particulate substrate that is coated with HA and in which the particulate substrate core is retained by the HA-coated substrate after the HA is prepared on its surface. Particulate substrates include spherical or oblong particles having diameters of between about 1 μm and about 1000 μm. For example, particles (also referred to as particulate substrates can be identified as small-sized particles (<about 50 μm), medium-sized particles (about 50 to about 100 μm), or large-sized particles (greater than about 100 μm). Particles can, of course, have other shapes, such as a shard-like shape. Where spherical particles are used as a substrate, the spherical particles can be monodisperse or polydisperse in size distribution. In other embodiments, the particulate substrate comprise structures selected from cubes, cuboids, prisms, pyramids, platonic solids, torus, cone, cylinder, spheres and mixtures thereof. In any of these embodiments, the particles have at least one dimension (length, width, diameter, and/or height) that is between about 1 μm and about 1000 μm; between about 5 μm and about 750 μm; between about 5 μm and about 600 μm; between about 5 μm and about 500 μm; between about 5 μm and about 400 μm; between about 5 μm and about 250 μm; between about 5 μm and about 150 μm; or between about 5 μm and about 100 μm.

The term “sample” refers to any composition containing a target molecule that is desired to be purified. The term “contaminant” refers to any impurity that is to be removed from a sample. In some embodiments, the sample is a composition comprising antibodies and other contaminating proteins from a cell culture.

As used herein, the terms “a”, “an” and “the” are intended to mean “one or more.” As used herein, the term “about” refers to the recited number and any value within 10% of the recited number and includes each discrete value such as ±1%, ±2%, +3%, +4%, ±5%, +6%, ±7%, ±8%, ±9% or ±10%. Thus, “about 5” refers to any value between 4.5 and 5.5, including 4.5 and 5.5.

The term “and/or” as used herein refers to and encompasses any and all possible combinations of one or more of the associated listed items. For example, the phrase “A, B, and/or C” includes A alone, B alone, C alone, the combination of A and B, the combination of A and C, the combination of B and C, and the combination of A. B, and C. Also, the term “or” is used in its inclusive sense (and not in its exclusive sense) so that when used, for example, to connect a list of items, the term “or” means one, some, or all of the items in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z).

The term “substrate” refers to a solid particulate substrate, such as beads, particles, or other particulate substrates. Such substrates are coated with calcium and phosphate to form HA. The substrate may be porous (micro-porous or macro-porous) or non-porous. The substrate can be derivatized with an epoxide or another group that can be derivatized to contain a hydroxyl group, amine group (e.g., a quarternary amine group), aldehyde group, azide group, alkyne group, alkene group, phosphate group, sulfonate group, sulfate group, and/or carboxylic acid group. Substrates can also comprise a hydroxyl group, amine group (e.g., a quarternary amine group), aldehyde group, azide group, alkyne group, alkene group, phosphate group, sulfonate group, sulfate group, and/or carboxylic acid group attached to a linker coupled to the substrate. Particulate substrates can be formed from methacrylate, polystyrene, agarose, dextran, cellulose, polyacrylamide, or any other suitable substrate that can be derivatized to have a hydroxyl group, amine group (e.g., a quarternary amine group), aldehyde group, azide group, alkyne group, alkene group, phosphate group, sulfonate group, sulfate group, and/or carboxylic acid exposed on the surface of the substrate. The substrate particles can have any shape, such a spherical or shard-like and can also be rigid or malleable. In certain embodiments, rigid substrates are preferred. The substrate can be polydisperse or monodisperse with respect to its size distribution. Porous substrates can contain pores of any desired size. For example, the pores can have a median diameter of about 0.5 micron or greater or the pores can have a median diameter less than about 0.5 micron or about 0.1 micron.

### Methods

Protein purification utilizing a particulate HA-coated substrate in accordance can be achieved by conventional means known to those of skill in the art. Examples of proteins include but are not limited to antibodies, enzymes, growth regulators, clotting factors, transcription factors, and phosphoproteins. In many such conventional procedures, the particulate HA-coated substrate prior to use is equilibrated with a buffer (“an equilibration buffer”) at the pH that will be used for the binding of the target molecule (e.g., antibody or non-antibody protein). Equilibration can be done with respect to all features that will affect the binding environment, including ionic strength and conductivity when appropriate.

In some embodiments, the particulate HA-coated substrates described herein can be used in “bind-elute” mode to purify a target molecule from a biological sample. In some embodiments, following binding of the target molecule to the particulate HA-coated substrate, a change in phosphate concentration pH can be used to elute the target molecule.

In some embodiments, once the particulate HA-coated substrate is equilibrated, the sample containing a target molecule is loaded onto the particulate HA-coated substrate (a “loading step”), the sample optionally being diluted or equilibrated into the equilibration buffer) and the target molecule is allowed to bind to the particulate HA-coated substrate. Once bound to the particulate HA-coated substrate, the particulate HA-coated substrate can be washed with a “wash buffer” to remove contaminants not bound to the particulate HA-coated substrate.

Non-limiting examples of buffers suitable for use in connection with chromatography using the disclosed particulate HA-coated substrate include phosphate buffers (e.g., monosodium, disodium, and/or trisodium phosphate buffers), ammonium phosphate, alkalicalcium phosphate, and potassium phosphate (monobasic and/or dibasic) buffers. The buffers are, generally, prepared at concentrations of about 5 mM to about 100 mM, about 5 mM to about 75 mM, about 5 mM to about 50 mM or about 20-50 mM. These buffers, may, optionally, further comprise a salt. Examples of salts that can be used for this purpose are alkali metal and alkaline earth metal halides, notably sodium and potassium halides, and as a specific example NaCl or KCl. Other salts include sulfates, acetates, bromides, perchlorates, iodides, thiocyanates and suitable cations, such as ammonium, alkali metals and alkaline earth metals.

Non-limiting examples of buffers suitable for use in connection with the disclosed chromatography substrate (particulate substrate) include acetate buffers (e.g., sodium acetate), acetic acid, malonic acid, succinate buffers, imidazole buffers, arginine buffers, glycine buffers, HEPES (2-[4-(2-hydroxyethyl)piperazin-1-yl]ethanesulfonic acid), BICINE (N,N-Bis(2-hydroxyethyl)glycine), Bis-tris (Bis-tris methane), Bis-tris propane, TRIS (Tris(hydroxymethyl)aminomethane), MES (2-Morpholinoethanesulfonic acid monohydrate or ACES (N-(2-Acetamido)-2-aminoethanesulfonic acid) buffers. The buffers are, generally, prepared at concentrations of about 10 mM to about 100 mM, or about 20-50 mM. Each of these buffers can contain calcium and/or phosphate ions, for example at a concentration of about 1 mM to about 50 mM, 1 mM to about 40 mM, 1 mM to about 30 mM, 1 mM to about 20 mM, 1 mM to about 10 mM, or 1 mM to about 5 mM.

Alternatively, conditions and reagents that are used as in standard HA-based chromatography can be used with the disclosed particulate HA-coated substrates. For example, any buffer can be used, such as those containing cations such as sodium, potassium, ammonium, magnesium, and calcium, and anions such as chloride, fluoride, acetate, phosphate, and citrate. The pH of the equilibration solution is typically about 6.0 or higher, in many cases the pH is within the range of about 6.5 to about 8.6 or a range of about 6.5 to about 7.8. In some embodiments, equilibration of a particulate HA-coated substrate as disclosed herein may take place in a solution comprising a Tris or a sodium phosphate buffer. The sodium phosphate buffer may be, for example, present at a concentration from about 0.5 mM to about 50 mM, or from about 10 mM to about 35 mM.

In some embodiments, the particulate HA-coated substrate may be washed with a wash buffer, such as the equilibration buffer, to remove any unbound proteins or substances that may have been present in the source liquid. The bound protein (e.g., antibody or non-antibody protein, as desired) can be subsequently eluted with an elution buffer. Isocratic elution, stepwise elution in which buffer conditions or salt conditions are changed, or gradient elution using, for example, a buffer at a constant pH and a salt gradient or a gradient of phosphate ions can be used for eluting a protein of interest.

In other embodiments, the binding and washing steps are performed with the inclusion of at least one salt in the sample and wash liquids. Examples of salts that can be used for this purpose are alkali metal and alkaline earth metal halides, notably sodium and potassium halides, and as a specific example sodium chloride. The concentration of the salt can vary; in most cases, an appropriate concentration will be one within the range of about 10 mM to about 2 M, about 10 mM to about 1.5 M, about 10 mM to about 1 M, about 10 mM to about 750 mM, about 10 mM to about 500 mM, about 10 mM to about 250 mM, about 20 mM to about 150 mM, about 20 mM, or about 150 mM. Other embodiments contemplate the use of different concentrations of phosphate ions in the binding and elution steps. In some embodiments, the concentration to phosphate ions ranges: between X mM and 1000 mM, where X is any integer between 1 and 999; between X mM and 750 mM, where X is any integer between 1 and 749; between X mM and 500 mM, where X is any integer between 1 and 499; between X mM and 250 mM, where X is any integer between 1 and 249; between X mM and 100 mM, where X is any integer between 1 and 99; between X mM and 50 mM, where X is any integer between 1 and 49. In certain embodiments, X is 1, 5, 10, 15, 20, 25, 30, 34, 40, 45, or 50. Optimal elution conditions for some proteins can involve a buffer with a higher salt concentration or a higher concentration of phosphate ions than that of the loading and/or wash buffer. In some instances, bound proteins can be eluted with a salt or phosphate gradient (see, for example, the examples provided herein). In other embodiments, a stepwise elution can be utilized in which the amount of salt or phosphate contained within a buffer is altered (e.g., increased) and passed over the column to elute bound protein.

The particulate HA-coated substrate can be utilized in any conventional configuration, including packed columns and fluidized or expanded-bed columns, and by any conventional method, including batchwise modes for loading, washes, and elution, as well as continuous or flow-through modes. The use of a packed flow-through column is particularly convenient, both for preparative-scale extractions and analytical-scale extractions. A column may thus range in diameter from about 1 mm to about 1 m, and in height from about 1 cm to about 30 cm or more.

The chromatographic steps described herein can be performed in a conventional purification configuration including, but not limited to, packed columns and fluidized or expanded-bed columns and by any conventional chromatography method including batch modes for loading, washing, and elution, as well as continuous or flow-through modes. In some embodiments, the medium is packed in a column having a diameter ranging from less than 0.5 centimeter to more than a meter and a column height ranging from less than one centimeter to more than 30 centimeters. In other embodiments, the particulate HA-coated substrate is provided in a spin column.

In other embodiments, the particulate HA-coated substrate is provided in a chromatography column, the sample is applied to the top of the column and gravity forces the sample, wash buffers and/or elution buffers through the column. In other embodiments, a column containing the HA-coated substrate can be run with or without pressure and from top to bottom or bottom to top, and the direction of the flow of fluid in the column can be reversed during the process. In some cases, it can be advantageous to reverse the flow of liquid while maintaining the packed configuration of the packed bed. The methods described herein can be used for purifying many types of target molecules, including viruses, naturally occurring proteins, antibodies, and recombinant proteins.

The output from the particulate HA-coated substrate can be monitored for the presence of the target molecule or other components of the sample, as desired, to determine fractions that contain the target molecule and that are free, or at least have a reduced amount, of contaminant compared to the original sample. In some embodiments, at least 90%, 95%, 99% of the contaminant in the sample is removed in the resulting purified target molecule fractions. An exemplary method for measuring output includes monitoring a characteristic absorbance wavelength for the target molecule. The term “fraction” is used to refer to a portion of the output of chromatography and is not intended to limit how the output is collected or whether the output is collected in parts or continuously.

Any antibody preparation can be used in the present invention, including unpurified or partially purified antibodies from natural, synthetic, and/or recombinant sources. Unpurified antibody preparations can come from various sources such as, for example, plasma, serum, ascites, milk, plant extracts, bacterial lysates, yeast lysates, or conditioned cell culture media. Partially purified preparations can come from unpurified preparations that have been processed by at least one chromatography, precipitation, other fractionation step, or any combination thereof. In some embodiments, the antibodies have not been purified by protein A affinity prior to purification.

In certain embodiments, the particulate HA-coated substrates can be used for purification of non-antibody proteins, including therapeutic proteins. Examples of therapeutic proteins include, but are not limited to, Factor VIII von Willebrand Factor enzymes, growth regulators, clotting factors, transcription factors and phosphoproteins.

Producing particulate HA-coated substrates

In general terms, a particulate hydroxyapatite (HA)-coated chromatography substrate can be produced in the following generalized method. First, a desired particulate polymeric chromatography support substrate is chosen based on its chemical and mechanical properties. This step is followed by growing a calcium phosphate (CaP) coating throughout and on the surface of the particulate substrate via alternating exposures to calcium ion containing solutions, washes, and phosphate containing solutions. Finally, the CaP layer is converted to hydroxyapatite via exposure to a strong base at elevated temperatures for a specified amount of time. Exemplary strong bases include, and are not limited to, LiOH, NaOH, KOH, RbOH, CsOH, Ca(OH)₂, Sr(OH)₂, and Ba(OH)₂. Considerations for each of these steps is as follows:

The particulate substrate for the hydroxyapatite-polymer is a free-flowing, chromatography polymeric substrate with a polar surface, preferably an ionically charged surface. Particulate polymers of varying hydrophobicity can be used, including but not limited to methacrylate-based, styrene-based, agarose-based, and polyacrylamide-based particulate polymers. Porous particulate substrates with high surface area are preferred but the HA-coated substrate can be made from particulate substrates having non-porous surfaces. Polar functionality or preferably surface charge can be incorporated into the particulate polymeric substrate during the initial polymerization process by using an appropriate monomer. Alternatively, polarity or surface charge can be introduced after polymerization via chemical modifications, for example coupling ligands to epoxide groups on the substrate. Types of surface charges include but are not limited to strong cation exchange ligands like sulphonates, strong anion exchange ligands like quaternary amines, and weak cation exchange groups like carboxylic acids, sulfates, and phosphates.

Particulate substrates of various diameters and/or dimensions can also be used, including small-sized particles (<50 μm in at least one dimension e.g., length, width, diameter, and/or height), medium-sized particles (about 50 to about 100 μm in at least one dimension e.g., length, width, diameter, and/or height), and large-sized particles (greater than about 100 μm in at least one dimension e.g., length, width, diameter, and/or height).

The method used to grow the CaP layer involves cyclic exposures of the particulate substrate to solutions of calcium ions, washes, phosphate ions, and further washes. Various types of calcium ion-containing and phosphate ion-containing solutions can be prepared. The calcium source is a solubilized salt of calcium and is selected to reduce the amount of undesired impurities. The preferred calcium source is calcium chloride. Calcium solutions of varying concentrations can be used, ranging but not limited to 50-1000 mM. Some embodiments utilize calcium concentrations between about 250 mM and about 500 mM. Solutions can be made of varying concentrations, ranging from but not limited to 10 mM to about 1000 mM, about 20 mM to about 750 mM, about 30 mM to about 500 mM, about 30 mM to about 400 mM, or a concentration of about 300 mM. Alternatively, the calcium solutions have a concentration between about 10 mM and about A mM, wherein A is any integer between 11 and 1000. Buffers that do not form insoluble precipitates with calcium can be incorporated, but a preferred solution contains only the chosen calcium salt.

The phosphate source can be any solubilized salt of phosphate and is selected to reduce the amount of undesired ions and other small molecules. A preferred phosphate source is dibasic sodium phosphate heptahydrate. The anhydrous form, as well as the potassium and ammonium salts, are also compatible. Phosphate solutions can be made of varying concentrations, ranging from but not limited to 10 mM to about 1000 mM, about 20 mM to about 750 mM, about 30 mM to about 500 mM, about 30 mM to about 400 mM, or a concentration of about 300 mM and may be, optionally, heated to a temperature of about 40° C. to about 100° C., about 45° C. to about 90° C., about 50° C. to about 80° C., or about 70° C. Alternatively, the phosphate solutions have a concentration between about 10 mM and about B mM, wherein B is any integer between 11 and 1000 and may be, optionally, heated to a temperature of about 40° C. to about 100° C., about 45° C. to about 90° C., about 50° C. to about 80° C., or about 70° C. Buffers that do not form insoluble precipitates with phosphates can be incorporated, but the preferred solution contains only the chosen phosphate salt.

For the deposition process, particulate substrates are exposed to the following cycles. For cation exchange substrates, CaP coatings were grown by repeatedly exposing the substrates to: (a) calcium solution, (b) water washes, (c) phosphate solution, and (d) water washes. For anion exchange substrates, CaP coatings were grown by repeatedly exposing the substrates to the following cycle of solutions: (a) phosphate solution, (b) water washes, (c) calcium solution, and (d) water washes. Switching these methods can be done but typically the first half does not contribute significantly to CaP growth. For polar, non-ionically charged particulate surfaces, either process can be used.

Different configurations can be used to expose the base particulate polymeric substrates to the various aqueous environments if the particulate substrate can be washed well between the calcium and phosphate solution exposures. Two exemplary configurations are a column format and a reactor format. In the column format, the particulate substrate is packed into a chromatographic column and the appropriate solutions are passed through the columns. Different parameters can be varied including the concentrations of calcium and phosphate solutions, flowrate, number of cycles, and type of base substrate used.

For the reactor format, the particulate substrate is placed in a reactor, preferably containing a fritted drain. For each step, either the calcium solution, phosphate solution, or water wash is added to the reactor. After agitating the slurry by mechanical stirring, swirling, or bubbling, the solution or water wash is removed from the particulate substrate. Various parameters can be changed to affect the amount of growth, morphology, and impurities/unwanted CaP debris. Parameters include, frit size and morphology, contact time with each solution, volume and concentrations of salt solutions, washing method (e.g. number, volume, duration), number of overall cycles, and method to agitate the substrate within the solution.

Conversion of the CaP coated particulate substrates to hydroxyapatite coated particulate substrates is done in a heated solution of a strong base, such as sodium hydroxide with agitation. Strong base (e.g., NaOH) concentration, time, and temperature, can be adjusted to alter the degree of conversion of the CaP layer into hydroxyapatite.

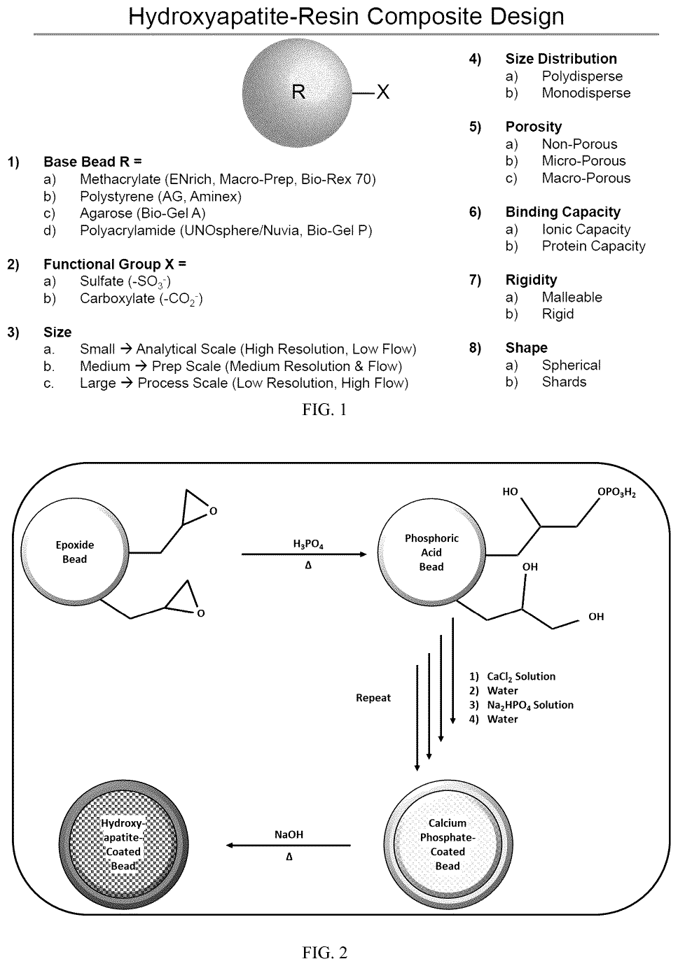

HA-coated substrates can be produced by contacting a solid particulate substrate (porous or non-porous) comprising a functional group with a series of solutions. The functional group associated with the substrate can be a hydroxyl group, amine group (e.g., a quartemary amine group), aldehyde group, azide group, alkyne group, alkene group, phosphate group, sulfonate group, sulfate group, and/or carboxylic acid group (see, for example, FIG. 1). Methods of producing HA-coated substrates comprise:
a) contacting a solid particulate substrate comprising a hydroxyl group, amine group, quaternary amine group, aldehyde group, azide group, alkyne group, alkene group, phosphate group, sulfonate group, sulfate group, and/or carboxylic acid group with a solution comprising calcium ions, with the proviso that if a substrate comprises positively charged groups is may be contacted with a phosphate containing solution and washed prior to contact with a solution comprising calcium ions (for example, (CaCl₂));
b) washing the solid substrate contacted with solution comprising calcium ions a solution (for example, water);
c) contacting the washed solid substrate of step b) with a solution comprising phosphate ions, such as the sodium salt of phosphoric acid (Na₂HPO₄) to form a solid substrate coated with a brushite form of calcium phosphate;
d) washing the solid substrate of step c) with a solution (for example, water); and
e) optionally repeating steps b), c), and d). When step e) is repeated, it can be repeated any number of times until a suitably HA-coated substrate is obtained. For example, step e) can be repeated Y times, where Y is any integer between 1 and 5000. In some embodiments, Y is an integer between 1 and 100, 1 and 50, 1 and 20, or 1 and 10. After the final step, for example step e), is completed, the brushite-coated substrate is treated with a base, such as sodium hydroxide and preferably heat (for example temperatures of about 20° C. to about 100° C. (or higher for example, up to about 200° C.), about 60° C. to about 90° C., about 65° C. to about 80° C., or about 70° C.) to form a hydroxyapatite-coated substrate (HA-coated substrate).

In other embodiments, when the HA-coated substrate starts with a substrate that comprises positively charged groups, the method comprises: a) contacting the solid porous substrate with a solution comprising phosphate ions; b) washing the solid porous substrate contacted with the solution comprising phosphate ions; c) contacting the solid porous substrate of step b) with a solution comprising calcium ions; d) washing the solid substrate contacted with the solution comprising calcium ions with a wash solution; e) contacting the washed solid substrate of step b) with a solution comprising phosphate ions to form a solid substrate coated with a brushite form of calcium phosphate; f) washing the solid substrate of step c) with a solution to form a brushite-coated substrate; g) optionally repeating steps c), d), e), and f); and h) treating the brushite coated substrate with a base to form a HA-coated substrate.

In instances where the solid substrate comprises an epoxide group, the epoxide-bearing substrate can be contacted with strong acids such as phosphoric acid, or solutions with reactive molecules containing 2 or more functional groups with at least one being a carboxylic acid to form a substrate bearing phosphate, carboxylate, or sulfate groups. In such methods, the epoxide-bearing substrate is contacted with phosphoric acid carboxylic acid, or sulfuric acid at a temperature of about 55° C. to about 100° C., about 60° C. to about 90° C., about 65° C. to about 80° C., or about 70° C. in order to form a substrate comprising bearing phosphate, carboxylate, or sulfate groups. These substrates can then be used in step a) of the method described above to form a HA-coated substrate.

### Additional Disclosure and Claimable Subject Matter

1. A hydroxyapatite (HA)-coated particle made by a method comprising:
a) contacting a solid porous or non-porous particulate substrate comprising a hydroxyl group, amine group, quarternary amine group, aldehyde group, azide group, alkyne group, alkene group, phosphate group, sulfonate group, sulfate group, and/or carboxylic acid with a solution comprising calcium ions, with the proviso that if a substrate comprises positively charged groups it may be contacted with a phosphate containing solution and washed prior to contact with a solution comprising calcium ions;
b) washing the solid substrate contacted with calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) treating the brushite coated substrate with a base to form a HA-coated substrate.

2. The HA-coated particle of embodiment 1, wherein when step e) is repeated, it is repeated Y times, where Y is any integer between 1 and 5000, Y is an integer between 1 and 100, Y is an integer between 1 and 50, Y is an integer between 1 and 20, or Y is an integer between 1 and 10.

3. The HA-coated particle of any one of embodiments 1-2, wherein the particulate substrate comprises methacrylate, polystyrene, agarose, polyacrylamide, dextran, cellulose, or mixtures thereof.

4. The HA-coated particle of any one of embodiments 1-3, wherein the particulate substrate is porous.

5. The HA-coated particle of any one of embodiments 1-3, wherein the particulate substrate is non-porous.

6. The HA-coated particle of any one of embodiments 1-5, wherein the particulate substrate is washed with water in steps b) and/or d).

7. The HA-coated substrate of any one of embodiments 1-6, wherein the particulate substrate comprises a sulfate group.

8. The HA-coated substrate of any one of embodiments 1-6, wherein the particulate substrate comprises a carboxylate group.

9. The HA-coated substrate of any one of embodiments 1-6, wherein the particulate substrate comprises a phosphate group.

10. The HA-coated particulate substrate of any one of embodiments 1-9, wherein the solution comprising phosphate ions is a sodium salt of phosphoric acid (Na₂HPO₄).

11. The HA-coated particulate substrate of any one of embodiments 1-10, wherein the solution comprising calcium ions is CaCl₂).

12. The HA-coated particulate substate of any preceding embodiment, wherein the calcium solution has a concentration between: about 50 to about 1000 mM; about 250 mM and about 500 mM; about 10 mM to about 1000 mM; about 20 mM to about 750 mM; about 30 mM to about 500 mM; about 30 mM to about 400 mM; about 10 mM and about A mM, wherein A is any integer between 11 and 1000; or about 300 mM.

13. The HA-coated particulate substate of any preceding embodiment, wherein the phosphate solution has a concentration between: about 10 mM to about 1000 mM; about 20 mM to about 750 mM; about 30 mM to about 500 mM; about 30 mM to about 400 mM; about 10 mM and about B mM, wherein B is any integer between 11 and 1000.

14. The HA-coated particulate substate of any preceding embodiment, wherein the particulate substrate comprises cubes, cuboids, prisms, pyramids, platonic solids, torus, cone, cylinder, spheres and mixtures thereof having at least one dimension that is between about 1 μm and about 1000 μm; between about 5 μm and about 750 μm; between about 5 μm and about 600 μm; between about 5 μm and about 500 μm; between about 5 μm and about 400 μm; between about 5 μm and about 250 μm; between about 5 μm and about 150 μm; or between about 5 μm and about 100 μm as a length, width, diameter, and/or height, the particulate substrate being monodisperse or polydisperse.

15. The HA-coated particulate substate of embodiment 14, wherein the particulate substrate is a sphere having a diameter of: between about 1 μm and about 1000 μm; less than about 50 μm, between about 50 μm and about 100 μm; or greater than 100 μm and less than about 1000 μm.

16. The HA-coated particulate substate of any one of embodiments 1-15, wherein brushite is converted to HA by treating the brushite-coated substrate with NaOH and is, optionally, heated.

17. The HA-coated particulate substate of embodiment 16, wherein the brushite-coated substrate is treated with NaOH and heated to a temperature of about 55° C. to about 200° C., about 60° C. to about 90° C., about 65° C. to about 80° C., or about 70° C.

18. The HA-coated particulate substate of embodiment 17, wherein the brushite-coated substrate is treated with NaOH and heated to a temperature of temperature of about 70° C.

19. A chromatography column comprising a plurality of HA-coated particulate substrates according to embodiments 1-15.

20. A method of performing chromatography, the method comprising:
contacting a sample comprising a target molecule to a plurality of HA-coated particulate substrates according to any one of embodiments 1-19 under conditions such that the target is not captured by the plurality of HA-coated particulate substrates; and
collecting the target molecule from eluate that has flowed through the plurality of HA-coated particulate substrates.

21. The method of embodiment 20, wherein the sample comprises a contaminant that is captured by the HA-coated particulate substrates.

22. The method of embodiment 20, wherein the collecting step comprises applying centrifugal force or a vacuum to the plurality of HA-coated particulate substrates and collecting one or more fractions enriched for the target molecule.

23. The method of embodiment 17, wherein the target molecule is an IgG antibody.

24. A method of performing chromatography, the method comprising:
contacting a sample comprising a target molecule to a plurality of HA-coated particulate substrates according to any one of embodiments 1-19 under conditions such that the target molecule is captured by the plurality of HA-coated particulate substrates; optionally washing the plurality of HA-coated particles with a buffer; and eluting and collecting the target molecule.

25. The method of embodiment 21, wherein the target molecule is an IgG antibody.

26. A method of making a hydroxyapatite (HA)-coated particle comprising:
a) contacting a solid porous or non-porous particulate substrate comprising a hydroxyl group, amine group, a quarternary amine group, aldehyde group, azide group, alkyne group, alkene group, phosphate group, sulfonate group, sulfate group, and/or carboxylic acid with a solution comprising calcium ions, with the proviso that if a substrate comprises positively charged groups it may be optionally contacted with a phosphate containing solution and optionally washed prior to contact with a solution comprising calcium ions;
b) washing the solid substrate contacted with calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) treating the brushite coated substrate with a base to form a HA-coated substrate.

27. The method of embodiment 26, wherein when step e) is repeated, it is repeated Y times, where Y is any integer between 1 and 5000, Y is an integer between 1 and 100, Y is an integer between 1 and 50, Y is an integer between 1 and 20, or Y is an integer between 1 and 10.

28. The method of any one of embodiments 26-27, wherein the particulate substrate comprises methacrylate, polystyrene, agarose, polyacrylamide, dextran, cellulose, or mixtures thereof.

29. The method of any one of embodiments 26-28, wherein the particulate substrate is porous.

30. The method of any one of embodiments 16-28, wherein the particulate substrate is non-porous.

31. The method of any one of embodiments 26-30, wherein the particulate substrate is washed with water in steps b) and/or d).

32. The method of any one of embodiments 26-31, wherein the particulate substrate comprises a sulfate group.

33. The method of any one of embodiments 26-31, wherein the particulate substrate comprises a carboxylate group.

34. The method of any one of embodiments 26-31, wherein the particulate substrate comprises a phosphate group.

35. The method of any one of embodiments 26-34, wherein the solution comprising phosphate ions is a sodium salt of phosphoric acid (Na₂HPO₄).

36. The method of any one of embodiments 26-35, wherein the solution comprising calcium ions is CaCl₂).

37. The method of any one of embodiments 23-36, wherein the calcium solution has a concentration between: about 50 to about 1000 mM; about 250 mM and about 500 mM; about 10 mM to about 1000 mM; about 20 mM to about 750 mM; about 30 mM to about 500 mM; about 30 mM to about 400 mM; about 10 mM and about A mM, wherein A is any integer between 11 and 1000; or about 300 mM.

38. The method of any one of embodiments 23-36, wherein the phosphate solution has a concentration between: about 10 mM to about 1000 mM; about 20 mM to about 750 mM; about 30 mM to about 500 mM; about 30 mM to about 400 mM; about 10 mM and about B mM, wherein B is any integer between 11 and 1000.

39. The method of any one of embodiments 23-38, wherein the particulate substrate comprises cubes, cuboids, prisms, pyramids, platonic solids, torus, cone, cylinder, spheres and mixtures thereof having at least one dimension that is between about 1 μm and about 1000 μm; between about 5 μm and about 750 μm; between about 5 μm and about 600 μm; between about 5 μm and about 500 μm; between about 5 μm and about 400 μm; between about 5 μm and about 250 μm; between about 5 μm and about 150 μm; or between about 5 μm and about 100 μm as a length, width, diameter, and/or height.

40. The method of embodiment 39, wherein the particulate substrate is a sphere having a diameter of: between about 1 μm and about 1000 μm; less than about 50 μm, between about 50 μm and about 100 μm; or greater than 100 μm and less than about 1000 μm.

41. The method of any one of embodiments 23-40, wherein brushite is converted to HA by treating the brushite-coated substrate with NaOH and is, optionally, heated.

42. The method of embodiment 41, wherein the brushite-coated substrate is treated with NaOH and heated to a temperature of about 55° C. to about 200° C., about 60° C. to about 90° C., about 65° C. to about 80° C., or about 70° C.

43. The method of embodiment 42, wherein the brushite-coated substrate is treated with NaOH and heated to a temperature of temperature of about 70° C.

All patents, patent applications, provisional applications, and publications referred to or cited herein are incorporated by reference in their entirety, including all figures and tables, to the extent they are not inconsistent with the explicit teachings of this specification.

### Example 1—Generalized Materials and Methods

### Macro-Prep High S/HA Composite Resins Grown in a Column Format

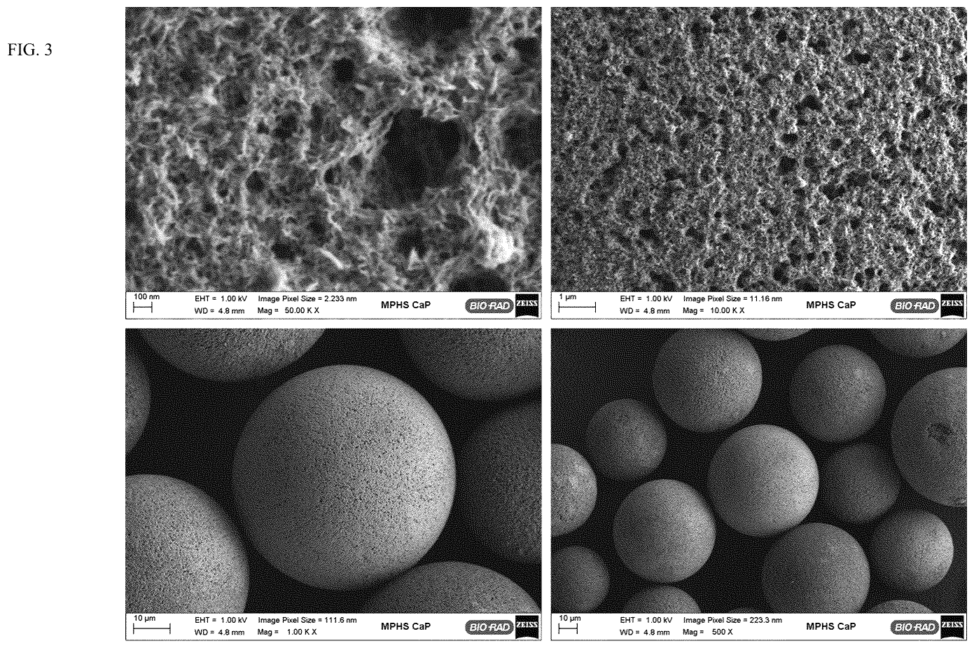

Bio-Rad Laboratories' Macro-Prep High S (sulphonated, microporous methacrylate-based particulate polymer), was chosen as a strong cation exchange resins substrate. 3-4 mL of polymer resin was loaded into a 6 mL column (1.6×3.0 cm) and set up to a liquid chromatography system. Flow rate was adjusted to change the contact time from 0.5 min to 3 min and the various solutions flowed vertically upward through the column. The CaP growth consisted of cycles of: (a) 25 mL (or 50 mL for the first cycle) 500 mM CaCl₂), (b) 25 mL deionized water, (c) 25 mL 300 mM Na₂PO₄, and (d) 25 mL of deionized water. In some iterations, 50 mM tris buffer was included in the CaCl₂ solution and/or water washes. The number of cycles ranged from 5-20 cycles. Afterwards, the resin was imaged by scanning electron microscopy, showing a resin well-covered in calcium phosphate needle-like structures (FIG. 3). Some iterations showed thinner needles while others showed flatter needles. Images also show CaP layer occurs throughout the resin.

### Example 2

### AG 50W-X8 200-400 Mesh/HA Composite Resins Grown in a Column Format

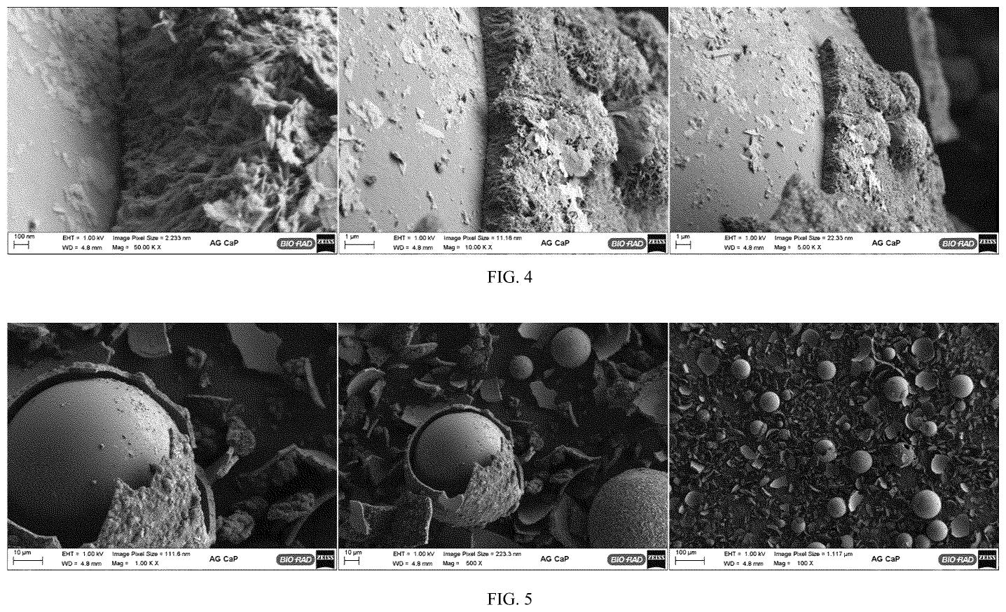

Bio-Rad Laboratories' AG 50W-X8 200-400 Mesh (sulphonated, nonporous, particulate polystyrene-based polymer), was used as the polymeric support. 3-4 mL of polymer resin was loaded into a 6 mL column (1.6×3.0 cm). Flow rate was set to 5 mL/min and flowed vertically upward through the column. The resin underwent the following cycles: (a) 25 mL (or 50 mL for the first cycle) 500 mM CaC₂, (b) 25 mL deionized water, (c) 25 mL 300 mM Na₂PO₄, and (d) 25 mL of deionized water. 10 cycles were carried out. Afterwards, the resin was imaged by scanning electron microscopy, showing resins well-covered in calcium phosphate needle-like structures (FIG. 4). Some beads were purposefully broken to show that a solid base polymer core covered in the CaP shell (FIG. 5).

### Example 3

### Nuvia S/HA Composite Resins Grown in a Column Format

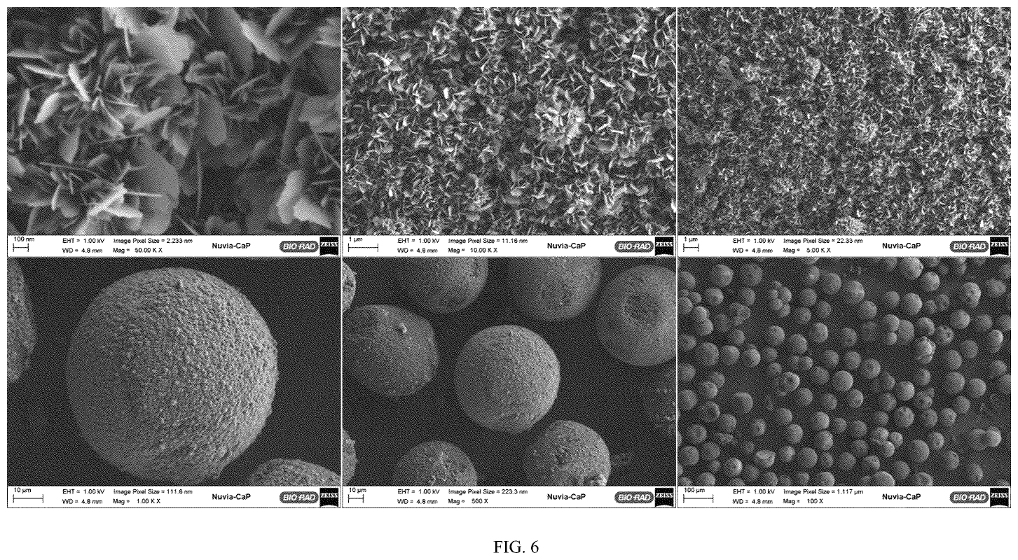

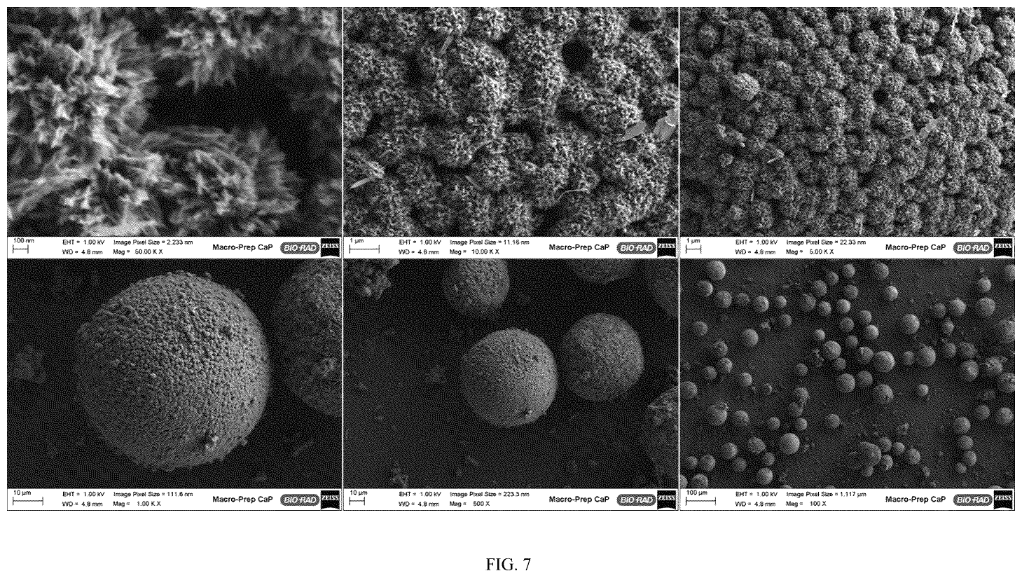

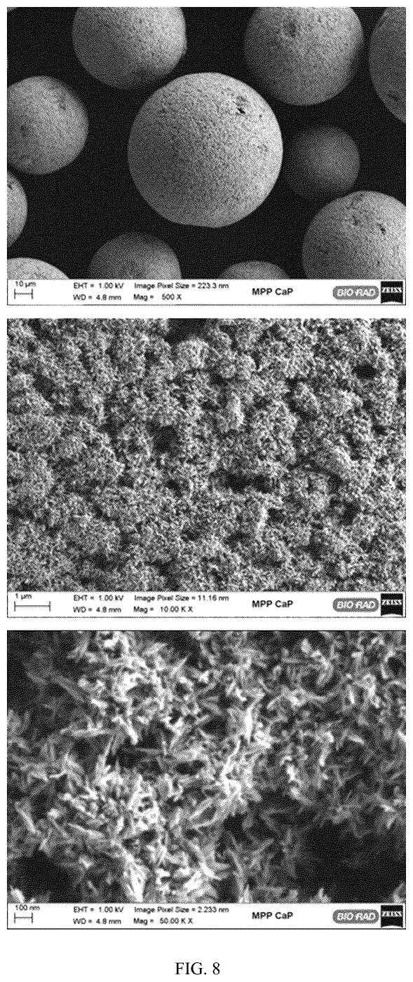

Bio-Rad Laboratories' Nuvia S (sulphonated, dextran-coated, particulate acrylamide-based polymer) was used as the polymeric support. 3-4 mL of polymer resin was loaded into a 6 mL column (1.6×3.0 cm). Flow rate was set to 5 mL/min and flowed vertically upward through the column. The resin underwent the following cycles: (a) 25 mL (or 50 mL for the first cycle) 500 mM CaCl₂), (b) 25 mL deionized water, (c) 25 mL 300 mM Na₂PO₄, and (d) 25 mL of deionized water. 10 cycles were carried out. Afterwards, the resin was imaged by scanning electron microscopy, showing resins well-covered in calcium phosphate needle-like structures (FIG. 6).

### Example 4

### Macro-Prep High Q/HA Composite Resins Grown in a Column Format

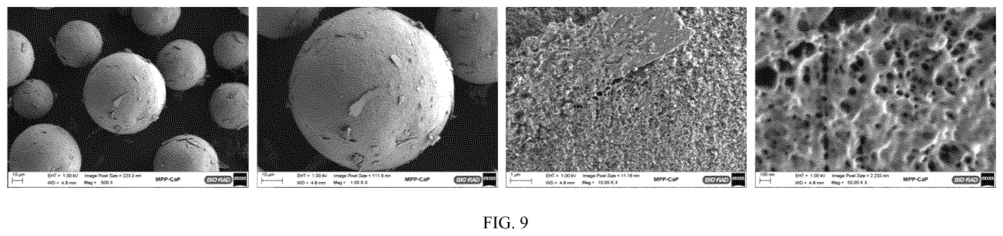

Bio-Rad Laboratories' Macro-Prep High Q (quaternary amine, particulate microporous methacrylate-based polymer) was used as the polymeric support. 3-4 mL of polymer resin was loaded into a 6 mL column (1.6×3.0 cm). Flow rate was set to 5 mL/min and flowed vertically upward through the column. The resin underwent the following cycles: (a) 25 mL (or 50 mL for the first cycle) 300 mM Na₂PO₄, (b) 25 mL deionized water, (c) 25 mL 500 mM CaCl₂) and (d) 25 mL of deionized water. 10 cycles were carried out. Afterwards, the resin was imaged by scanning electron microscopy, showing resins well-covered in calcium phosphate needle-like structures (FIG. 7).

### Example 5

### Macro-Prep-P/HA Composite Grown in Reactor Format

A Macro-Prep particulate precursor resin containing epoxides was reacted with concentrated phosphoric acid at 70° C. for 3 hours to create a phosphate functionalized Macro-Prep based cation exchange resin. The resulting resin, MPP, was tested for conversion by ATR-FTIR and the modification was quantitated by pH titration.

25 mL of resin was added to a reaction vessel containing frits at the bottom that could be drained by applying vacuum. For CaP growth cycling, solution was mixed with the resin and drained before proceeding to the next step or follow-up washes. Various mixing methods were tested from swirling the container and over-head mixing. Solutions were added as follows: (a) 50 mL 500 mM CaCl₂), (b) 3 washes of 50 mL deionized water, (c) 50 mL 300 mM Na₂PO₄, and (d) 3 washes of 50 mL deionized water. 10 cycles were carried out. Some iterations used different frits, reactors, and number of washes.

Afterwards, the resin was imaged by scanning electron microscopy, and 10,000× images show the resin is covered in rough surface of calcium phosphate (FIG. 8). Distinct needles were not observed, and 50,000× magnification shows a smoother surface speckled with holes. Depending on the quality of washing, some batches had larger plate-like CaP structures embedded in the surface or formed separately from the resin surface (FIG. 9). Resin was analyzed by FT-IR (Fourier transform infrared spectroscopy) showing a hydroxyapatite like signature with broad peaks (FIG. 10).

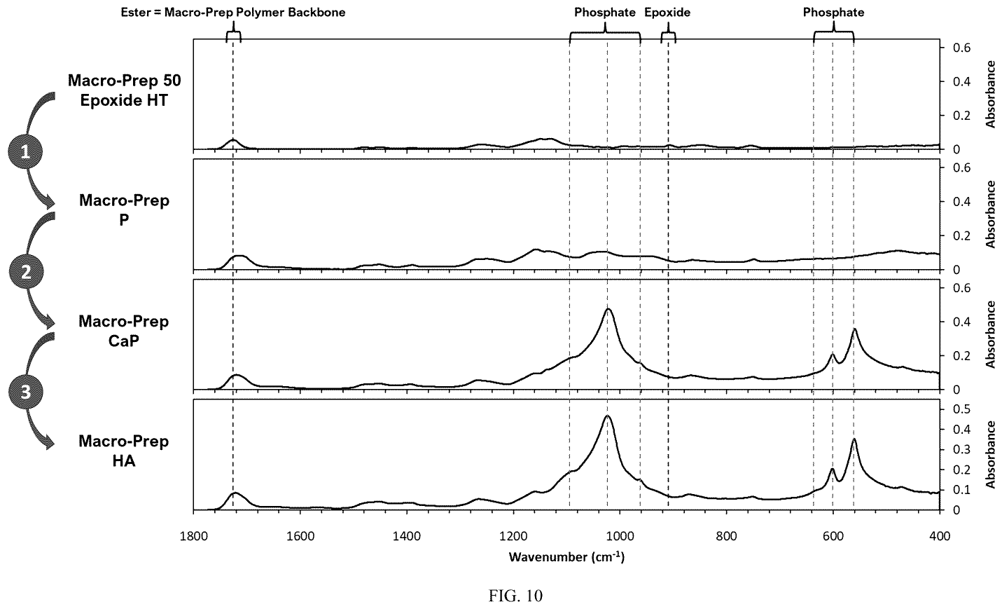

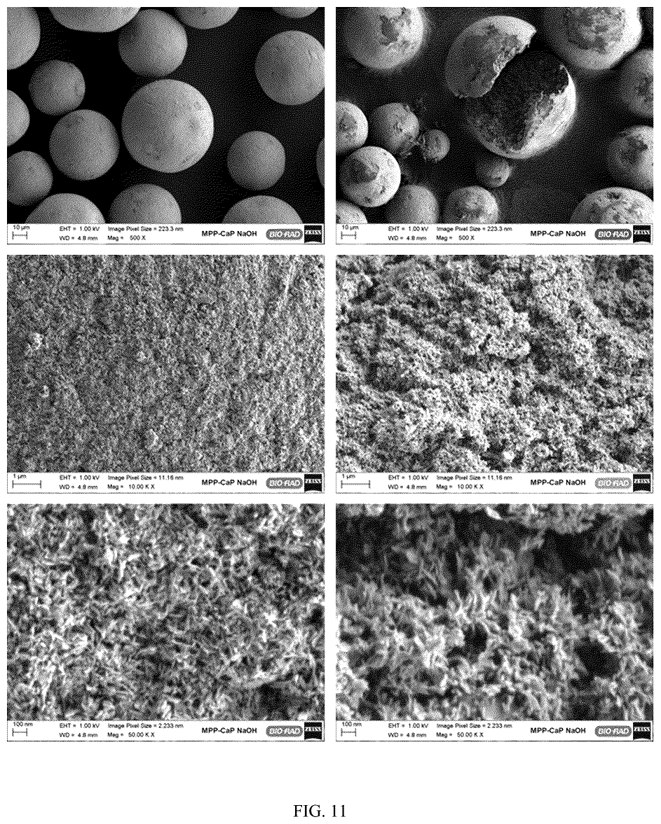

CaP-coated resins were converted into hydroxyapatite coated resins using one of two methods. The resin was shaken in a 70° C. hot water while suspended in either 100 mL of 2.25 N NaOH for 4 h or 5N NaOH for 6 hours. Afterwards, the slurry was diluted with water, and the resin was washed in a Buchner funnel with copious amounts of water to remove the NaOH. The resin was imaged by scanning electron microscopy, showing a resin well-covered in hydroxyapatite needle-like structures (FIG. 11), and the phase was confirmed by ATR-FTIR (FIG. 10).

### Example 6

### UNOsphere S/HA Composite Grown in Reactor Format

25 mL of resin was added to a reaction vessel containing frits at the bottom that could be drained by applying vacuum. For CaP growth cycling, solution was mixed with the resin and drained before proceeding to the next step or follow-up washes. Various mixing methods were tested from swirling the container and over-head mixing. Solutions were added as follows: (a) 50 mL 500 mM CaCl₂), (b) 3 washes of 50 mL deionized water, (c) 50 mL 300 mM Na₂PO₄, and (d) 3 washes of 50 mL deionized water. 10 cycles were carried out. Some iterations used different frits, reactors, and number of washes.

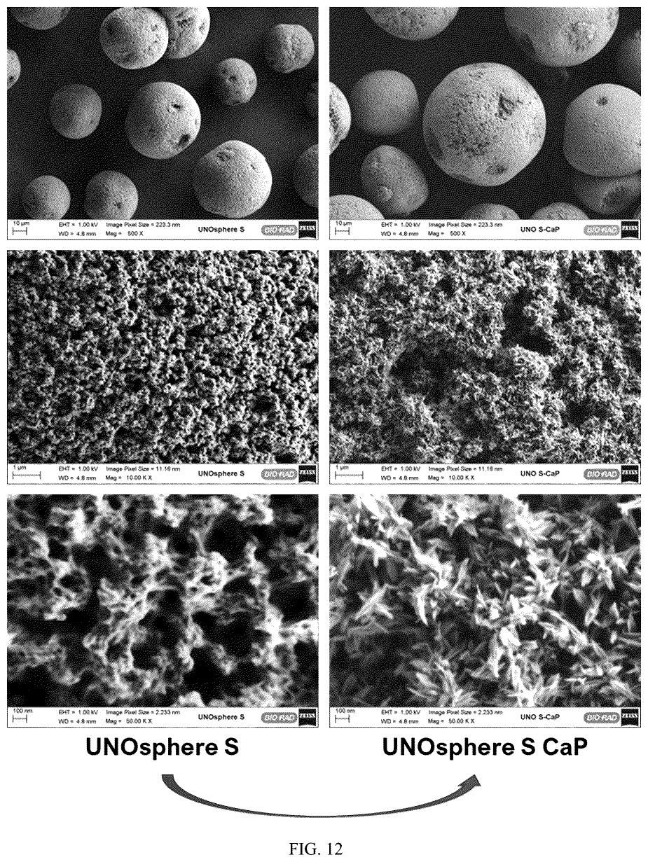

Afterwards, the resin was imaged by scanning electron microscopy, and 10,000× images show the resin is covered in rough surface of calcium phosphate (FIG. 12).

### Example 7

### Performance of Macro-Prep HA Composite

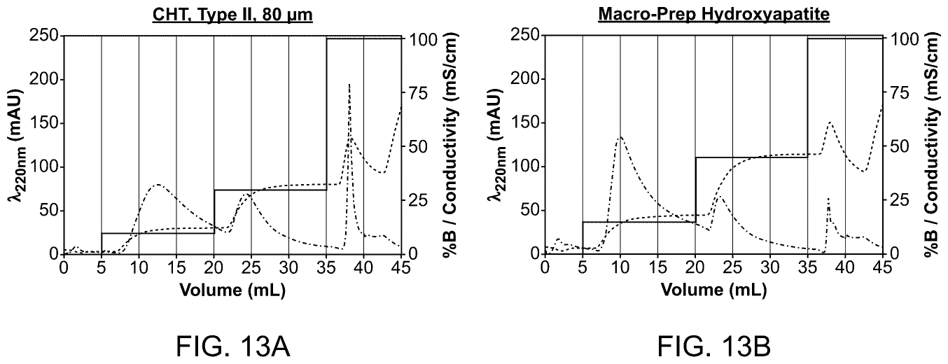

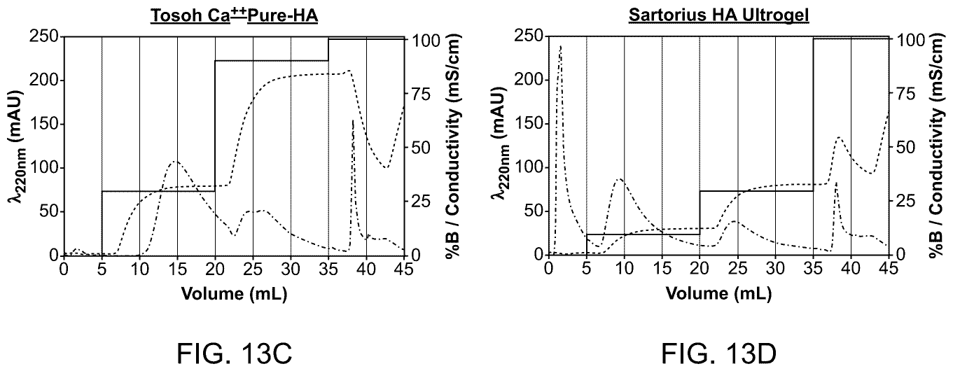

This example demonstrates the chromatographic performance of Macro-Prep HA (material from example 5). 1.2 mL of Macro-Prep HA is packed in a 1 mL chromatography column compared to commercial resins (FIGS. 13A-13D). The conditions were as followed:
Column: 0.56×4.00 cm
Flow Rate: 2 mLmin
Sample: 220 μg mAb S in 1.0 mL 5 mM Sodium Phosphate, pH 7.0
Equilibration: 20 mM Sodium Phosphate, pH 7.0, 10 column volumes
Post-Loading: 20 mM Sodium Phosphate, pH 7.0, 5 column volumes
Elution: Buffer A: 20 mM Sodium Phosphate, pH 7.0
Buffer B: 20 mM Sodium Phosphate, 1 M Sodium Chloride, pH 7.0
   (Step 1) 15% B, 15 Column Volumes;
   (Step 2) 45% B, 15 Column Volumes
Strip: 400 mM Sodium Phosphate, pH 6.8, 5 column volumes

### Example 8

### Performance of Macro-Prep HA Composite

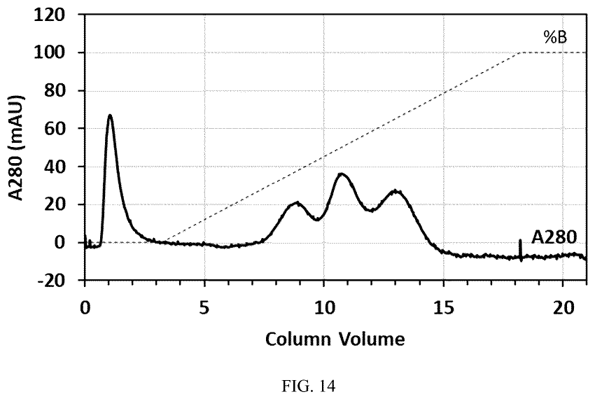

This example demonstrates the chromatographic performance of Macro-Prep HA (material from example 5). 1.1 mL of Macro-Prep HA is packed in a 1 mL chromatography column. The elution profile of this composite is shown in FIG. 14. The conditions were as followed:
Column: 0.56×4.00 cm
Flow Rate: 150 cm/h (0.616 mLmin)
Sample: 25 μL protein mixture (10 mg/mL Ovalbumin, 5 mg/mL Myoglobin, 5 mg/mL, α-chymotrypsinogen A, 5 mg/mL Cytochrome C in 10 mM sodium phosphate, pH 7.2)
Equilibration: 10 mM Sodium Phosphate+10 mM HEPES, pH 7.2, 10 column volumes
Post-Loading: 10 mM Sodium Phosphate+10 mM HEPES, pH 7.2, 3 column volumes
Elution: Buffer A: 10 mM Sodium Phosphate+10 mM HEPES, pH 7.2
   Buffer B: 400 mM Sodium Phosphate+10 mM HEPES, pH 7.2
   Gradient: 0-75% B, 15 column volumes, hold 75% B, 3 CV

We claim:

1. A hydroxyapatite (HA)-coated particle made by a method comprising:
a) contacting a solid porous or non-porous particulate substrate comprising a hydroxyl group, amine group, quarternary amine group, aldehyde group, azide group, alkyne group, alkene group, phosphate group, sulfonate group, sulfate group, and/or carboxylic acid with a solution comprising calcium ions, with the proviso that if a substrate comprises positively charged groups it may be contacted with a phosphate containing solution and washed prior to contact with a solution comprising calcium ions;
b) washing the solid substrate contacted with calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) treating the brushite coated substrate with a base to form a HA-coated substrate.

2. The HA-coated particle of claim 1, wherein when step e) is repeated, it is repeated Y times, where Y is any integer between 1 and 5000, Y is an integer between 1 and 100, Y is an integer between 1 and 50, Y is an integer between 1 and 20, or Y is an integer between 1 and 10.

3. The HA-coated particle of claim 1, wherein the particulate substrate comprises methacrylate, polystyrene, agarose, polyacrylamide, dextran, cellulose, or mixtures thereof.

4. The HA-coated particle of claim 1, wherein the particulate substrate is porous.

5. The HA-coated particle of claim 1, wherein the particulate substrate is non-porous.

6. The HA-coated particle of claim 1, wherein the particulate substrate is washed with water in steps b) and/or d).

7. The HA-coated substrate of claim 1, wherein the particulate substrate comprises a sulfate group.

8. The HA-coated substrate of claim 1, wherein the particulate substrate comprises a carboxylate group.

9. The HA-coated substrate of claim 1, wherein the particulate substrate comprises a phosphate group.

10. The HA-coated particulate substrate of claim 1, wherein the solution comprising phosphate ions is a sodium salt of phosphoric acid (Na₂HPO₄).

11. The HA-coated particulate substrate of claim 1, wherein the solution comprising calcium ions is CaCl₂).

12. The HA-coated particulate substate of claim 1, wherein the calcium solution has a concentration between: about 50 to about 1000 mM; about 250 mM and about 500 mM; about 10 mM to about 1000 mM; about 20 mM to about 750 mM; about 30 mM to about 500 mM; about 30 mM to about 400 mM; about 10 mM and about A mM, wherein A is any integer between 11 and 1000; or about 300 mM.

13. The HA-coated particulate substate of claim 1, wherein the phosphate solution has a concentration between: about 10 mM to about 1000 mM; about 20 mM to about 750 mM; about 30 mM to about 500 mM; about 30 mM to about 400 mM; about 10 mM and about B mM, wherein B is any integer between 11 and 1000.

14. The HA-coated particulate substate of claim 1, wherein brushite is converted to HA by treating the brushite-coated substrate with NaOH and is, optionally, heated.

15. The HA-coated particulate substate of claim 14, wherein the brushite-coated substrate is treated with NaOH and heated to a temperature of about 55° C. to about 200° C., about 60° C. to about 90° C., about 65° C. to about 80° C., or about 70° C.

16. The HA-coated particulate substate of claim 15, wherein the brushite-coated substrate is treated with NaOH and heated to a temperature of temperature of about 70° C.

17. A chromatography column comprising a plurality of HA-coated particulate substrates according to claim 1.

18. A method of performing chromatography, the method comprising:
contacting a sample comprising a target molecule to a plurality of HA-coated particulate substrates according to claim 1 under conditions such that the target is not captured by the plurality of HA-coated particulate substrates; and
collecting the target molecule from eluate that has flowed through the plurality of HA-coated particulate substrates.

19. A method of performing chromatography, the method comprising:
contacting a sample comprising a target molecule to a plurality of HA-coated particulate substrates according to claim 1 under conditions such that the target molecule is captured by the plurality of HA-coated particulate substrates;
optionally washing the plurality of HA-coated particles with a buffer; and
eluting and collecting the target molecule.

20. A method of making a hydroxyapatite (HA)-coated particle comprising:
a) contacting a solid porous or non-porous particulate substrate comprising a hydroxyl group, amine group, a quarternary amine group, aldehyde group, azide group, alkyne group, alkene group, phosphate group, sulfonate group, sulfate group, and/or carboxylic acid with a solution comprising calcium ions, with the proviso that if a substrate comprises positively charged groups it may be optionally contacted with a phosphate containing solution and optionally washed prior to contact with a solution comprising calcium ions;
b) washing the solid substrate contacted with calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) treating the brushite coated substrate with a base to form a HA-coated substrate.
